(19) United States
(12) Patent Application Publication
(10) Pub. No.: US 2024/0185451 A1
(43) Pub. Date: Jun. 6, 2024

(54) COMPUTER-READABLE RECORDING MEDIUM STORING POSTURE SPECIFYING PROGRAM, POSTURE SPECIFYING METHOD, AND INFORMATION PROCESSING APPARATUS

(71) Applicant: FUJITSU LIMITED, Kawasaki-shi (JP)

(72) Inventor: Ryotaro SANO, Yokohama (JP)

(73) Assignee: FUJITSU LIMITED, Kawasaki-shi (JP)

(21) Appl. No.: 18/428,091

(22) Filed: Jan. 31, 2024

Related U.S. Application Data
(63) Continuation of application No. PCT/JP21/28859, filed on Aug. 3, 2021.

(51) Int. Cl. G06T 7/73

(52) U.S. Cl. CPC G06T 7/73; G06T 2207/20044

(57) ABSTRACT

A non-transitory computer-readable recording medium stores a posture specification program causing a computer to execute: generating skeleton information indicating two dimensional coordinates of a plurality of joints of a person based on visual information which is obtained by capturing the person; setting angles of the plurality of joints and a direction of a part of the person based on the skeleton information; and specifying a posture of the person based on the angles of the plurality of joints and the direction of the part of the person.

### CROSS-REFERENCE TO RELATED APPLICATION

This application is a continuation application of International Application PCT/JP2021/028859 filed on Aug. 3, 2021 and designated the U.S., the entire contents of which are incorporated herein by reference.

### FIELD

The present embodiment relates to a posture specifying program and the like.

### BACKGROUND

In recent years, there is a technique for specifying a position of a joint of a person by analyzing visual information obtained by capturing the person with a camera and estimating a posture of the person. In such a technique, a plurality of joint angles are specified from the position of the joint, and the posture corresponding to the joint angles is estimated.

Related art is disclosed in International Publication Pamphlet NO. WO 2019/049216.

### SUMMARY

According to one aspect of the embodiments, a non-transitory computer-readable recording medium stores a posture specification program causing a computer to execute: generating skeleton information indicating two dimensional coordinates of a plurality of joints of a person based on visual information which is obtained by capturing the person; setting angles of the plurality of joints and a direction of a part of the person based on the skeleton information; and specifying a posture of the person based on the angles of the plurality of joints and the direction of the part of the person.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for supplementary explanation of a problem.

FIG. 2 is a diagram illustrating a system according to a present embodiment.

FIG. 3 is a diagram illustrating an example of a joint model.

FIG. 4 is a diagram for explaining a setting policy of vertical information and horizontal information by an information processing apparatus;

FIG. 5 is a diagram for explaining a process of the information processing apparatus;

FIG. 6 is a functional block diagram illustrating a configuration of the information processing apparatus according to the present embodiment.

FIG. 7 is a diagram illustrating an example of a data structure of a posture determination table;

FIG. 8 is a diagram for explaining an example of a first cutout process;

FIG. 9 is a diagram for explaining an example of a second cutout process;

FIG. 10 is a diagram for explaining an example of a third cutout process;

FIG. 11 is a diagram illustrating an example of an evaluation screen.

FIG. 12 is a flowchart illustrating a process procedure of the information processing apparatus according to the present embodiment;

FIG. 13 is a diagram illustrating an example of a hardware configuration of a computer that realizes the same functions as those of the information processing apparatus according to the embodiment;

FIG. 14 is a diagram for explaining a problem of the technique;

### DESCRIPTION OF EMBODIMENTS

However, the above-described technique has a problem that the posture of the person may not be uniquely specified.

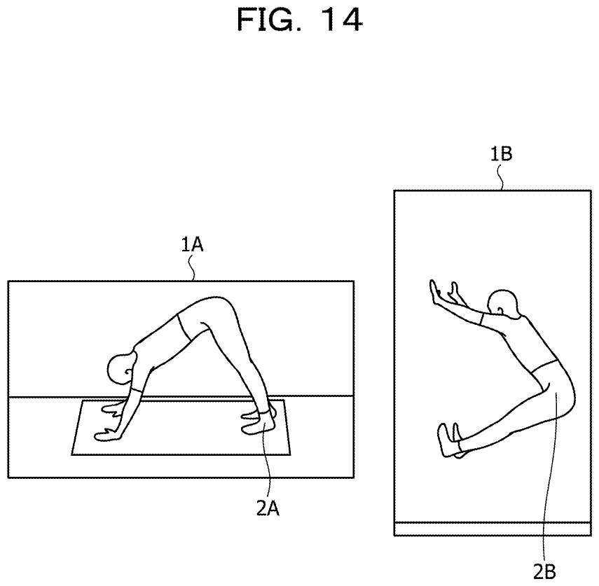

FIG. 14 is a diagram for explaining a problem of the technique. In an image 1A illustrated in FIG. 14, the posture of a person 2A is a posture in which the person 2A sticks out his/her buttock while touching a floor with his/her hand. On the other hand, in a image 1B illustrated in FIG. 14, the posture of the person 2B is a posture in which the person 2B jumps and forms a dogleg shape. The posture of the person 2A and the posture of the person 2B are different postures, but the joint angle of the person 2A and the joint angle of the person 2B are the same joint angle.

In the related art, since the posture is specified by focusing on the angles of the joints, the posture of the person 2A and the posture of the person 2B, which are illustrated in FIG. 14, may not be specified separately.

According to an aspect of the present disclosure, there is provided a posture specifying program, a posture specifying method, and an information processing apparatus capable of uniquely specifying a posture of a person.

Hereinafter, embodiments of a posture specifying program, a posture specifying method, and an information processing apparatus disclosed in the present application will be described in detail with reference to the drawings. Note that the invention is not limited to the embodiments.

### Example

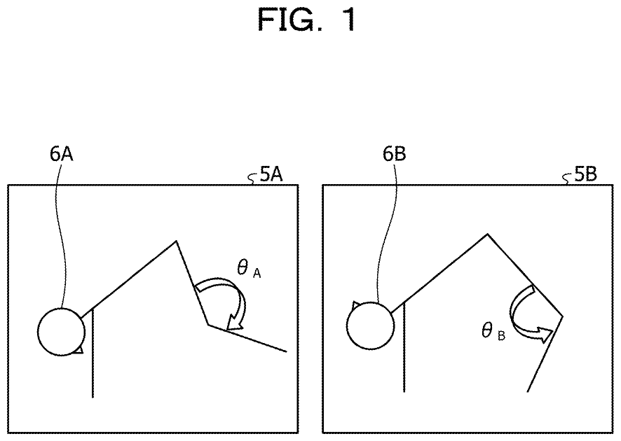

Before describing the present embodiment, an example in which the posture may not be uniquely specified when a posture estimation is attempted using only the joint angle will be described. FIG. 1 is a diagram for supplementary explanation of the problem. As a premise, a person is photographed by a monocular camera, and an image frame is analyzed to specify skeleton data of the person. The skeleton data includes two dimensional coordinates of a plurality of joints.

In an image frame 5A of FIG. 1, a skeleton (left shoulder) on the left side of a person 6A is in front, and the person takes a posture of “forward bending” posture. In an image frame 5B, the skeleton on the right side (right shoulder) of a person 6B is in front, and the person takes a posture of “bridge”. Here, a knee joint angle θ_{A} illustrated in the image frame 5A and a knee joint angle θ_{B} illustrated in the image frame 5B are the same joint angle.

The related apparatus estimates the posture of the person using only the joint angles obtained from the skeleton data, and therefore does not distinguish which skeleton of the person on the left side or on the right side is in front. Therefore, the apparatus may not specify whether the posture of the person 6A in the image frame 5A is “forward bending” or “bridge”. Similarly, it is not possible to specify whether the posture of the person 6B in the image frame 6sB is “forward bending” or “bridge”.

For example, when only the joint angle obtained from the skeleton data is used as in the apparatus, the posture of the person may not be uniquely specified.

When the posture of the person 6A in the image frame 5A is “bridge” or when the posture of the person 6B is “forward bending”, the knees are bent in an unusual direction due to a human body structure, but the apparatus may not distinguish such a point.

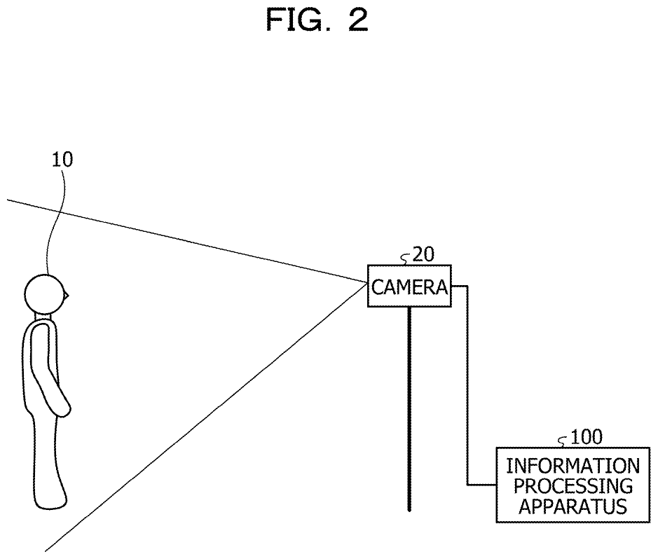

Next, an example of a system according to the present embodiment will be described. FIG. 2 is a diagram illustrating a system according to the present embodiment. As illustrated in FIG. 2, the system includes a camera 20 and an information processing apparatus 100. The camera 20 and the information processing apparatus 100 are coupled to each other wirelessly or by wire.

The camera 20 is a monocular camera that captures an image of the person 10. The camera 20 transmits data of the captured video to the information processing apparatus 100. In the following description, the data of the video is referred to as video data. The video data includes a plurality of time-series image frames. Each image frame is assigned a frame number in ascending order of time series. One image frame corresponds to static image captured by the camera 20 at a certain timing.

The information processing apparatus 100 is an apparatus that specifies the posture of the person 10 based on the video data acquired from the camera 20. The information processing apparatus 100 analyzes an image frame included in the video data to specify the skeleton data of the person 10. The skeleton data includes two dimensional coordinates of a plurality of joints. The information processing apparatus 100 specifies the joint angle and a direction of a part based on the skeleton data, and specifies the posture of the person 10 by combining the joint angle and the direction of the part.

The information processing apparatus 100 uses a direction of an upper body and a direction of a lower body as an example of the direction of the part. Each of the direction of the upper body and the direction of the lower body is given vertical information and horizontal information. As will be described later, one information of the vertical information and the horizontal information may be set to “NULL” depending on a setting policy.

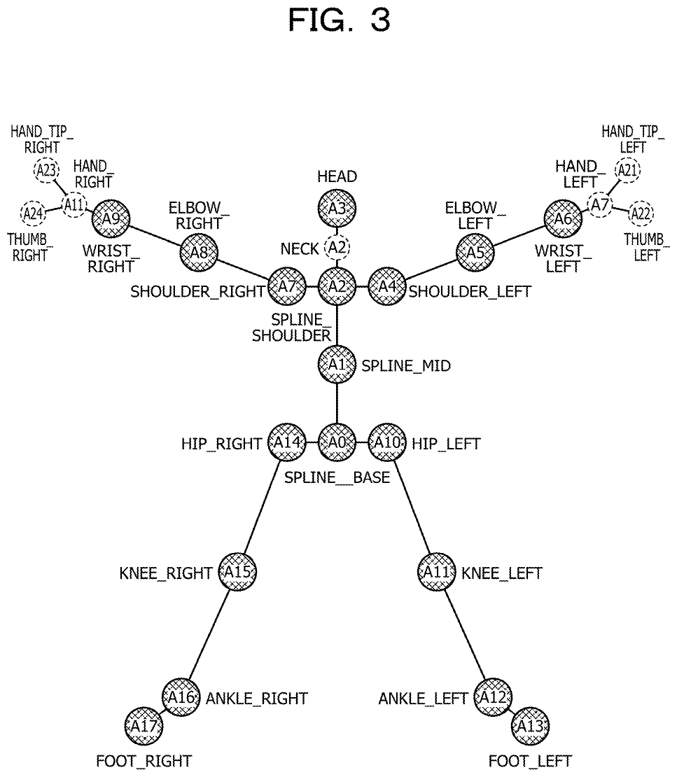

FIG. 3 is a diagram illustrating an example of a joint model. For example, the joints of the human body include joints A0 to A24. For convenience of description, an “angle of the upper body” and an “angle of the lower body” are defined. The information processing apparatus 100 determines the vertical information and the horizontal information to be given to the direction of the upper body based on the angle of the upper body. The information processing apparatus 100 determines the vertical information and the horizontal information to be given to the direction of the lower body based on the angle of the lower body.

In the present embodiment, as an example, the angle of the upper body is an angle determined based on a line segment extending from the A0 of the joints to the A2 of the joints in the two dimensional skeleton data and a horizontal direction.

The angle of the lower body is an angle which is determined based on a line segment extending from the A14 of the joints to the A15 the joints (from the A10 of the joints to the A11 of the joints) and the horizontal direction. There are two types of angles of the lower body, and in the present embodiment, for convenience of description, a case where right and left thighs of the person 10 overlap each other is assumed, and the description is given using the angle of one lower body, but the angles of both lower bodies may also be used.

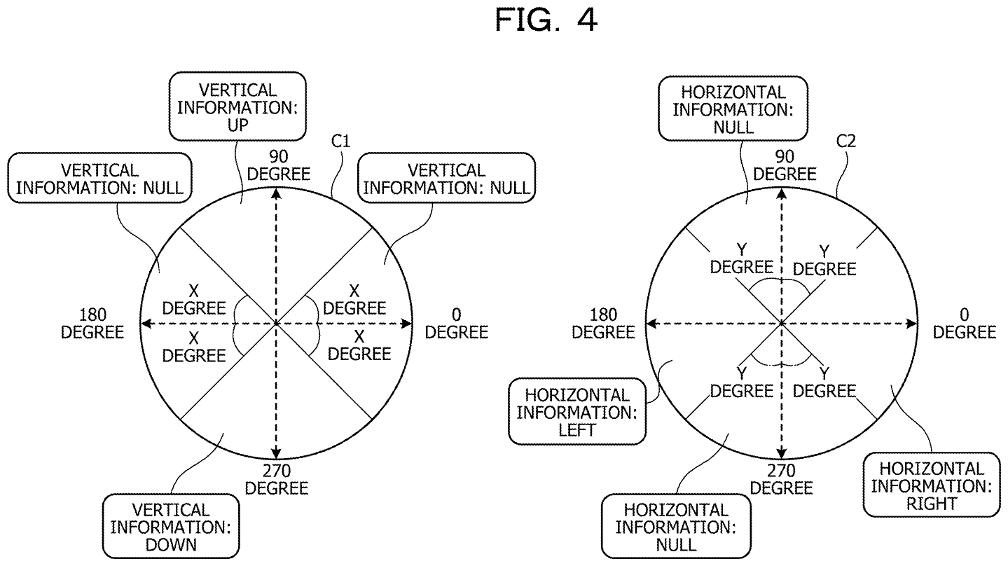

FIG. 4 is a diagram for explaining a setting policy of the vertical information and the horizontal information by the information processing apparatus. The setting policy of the vertical information will be described using a circle C1. When the angle is around 0 degrees or around 180 degrees, the vertical direction is likely to change. Therefore, the information processing apparatus 100 sets the vertical information to “NULL” when the angle is included in “0 degree−X degree” to “0 degree+X degree” and “180 degree−X degree” to “180 degree+X degree”. The value of X may be changed as appropriate.

For example, when the angle of the upper body is included in “0 degree−X degree” to “0 degree+X degree”, the information processing apparatus 100 sets the vertical information to be given to the direction of the upper body to “NULL”. When the angle of the upper body is included in “180 degree−X degree” to “180 degree+X degree”, the information processing apparatus 100 sets the vertical information to be given to the direction of the upper body to “NULL”.

In a case where the angle of the upper body is included in “0 degree+X degree” to “180 degree−X degree”, the information processing apparatus 100 sets the vertical information to be given to the direction of the upper body to “up”. When the angle of the upper body is included in “180 degree+X degree” to “0 degree−X degree”, the information processing apparatus 100 sets the vertical information to be given to the direction of the upper body to “down”.

Similarly, when the angle of the lower body is included in “0 degree−X degree” to “0 degree+X degree”, the information processing apparatus 100 sets the vertical information to be given to the direction of the lower body to “NULL”. When the angle of the lower body is included in “180 degree−X degree” to “180 degree+X degree”, the information processing apparatus 100 sets the vertical information to be given to the direction of the lower body to “NULL”.

When the angle of the lower body is included in the range of “0 degree+X degree” to “180 degree−X degree”, the information processing apparatus 100 sets the vertical information to be given to the direction of the lower body to “up”. In a case where the angle of the lower body is included in “180 degree+X degree” to “0 degree−X degree”, the information processing apparatus 100 sets the vertical information to be given to the direction of the lower body to “down”.

Next, the setting policy of the horizontal information will be described using a circle C2. When the angle is around 90 degree or around 280 degree, the horizontal direction is likely to change. Therefore, the information processing apparatus 100 sets the horizontal information to “NULL” in a case where the angle is included in “90 degree−Y degree” to “90 degree+Y degree” and “270 degree−Y degree” to “270 degree+Y degree”. The value of Y may be changed as appropriate.

For example, when the angle of the upper body is included in “90 degree−Y degree” to “90 degree+Y degree”, the information processing apparatus 100 sets the horizontal information to be given to the direction of the upper body to “NULL”. When the angle of the upper body is included in “270 degree−Y degree” to “270 degree+Y degree”, the information processing apparatus 100 sets the horizontal information to be given to the direction of the upper body to “NULL”.

When the angle of the upper body is included in “90 degree+Y degree” to “270 degree−Y degree”, the information processing apparatus 100 sets the horizontal information to be given to the direction of the upper body to “left”. In a case where the angle of the upper body is included in “270 degree+Y degree” to “0 degree−Y degree”, the information processing apparatus 100 sets the horizontal information to be given to the direction of the upper body to “right”.

Similarly, when the angle of the lower body is included in “90 degree−Y degree” to “90 degree+Y degree”, the information processing apparatus 100 sets the horizontal information to be given to the direction of the lower body to “NULL”. In a case where the angle of the lower body is included in “270 degree−Y degree” to “270 degree+Y degree”, the information processing apparatus 100 sets the horizontal information to be given to the direction of the lower body to “NULL”.

In a case where the angle of the lower body is included in “90 degree+Y degree” to “270 degree−Y degree”, the information processing apparatus 100 sets the horizontal information to be given to the direction of the lower body to “left”. In a case where the angle of the lower body is included in “270 degree+Y degree” to “0 degree−Y degree”, the information processing apparatus 100 sets the horizontal information to be given to the direction of the lower body to “right”.

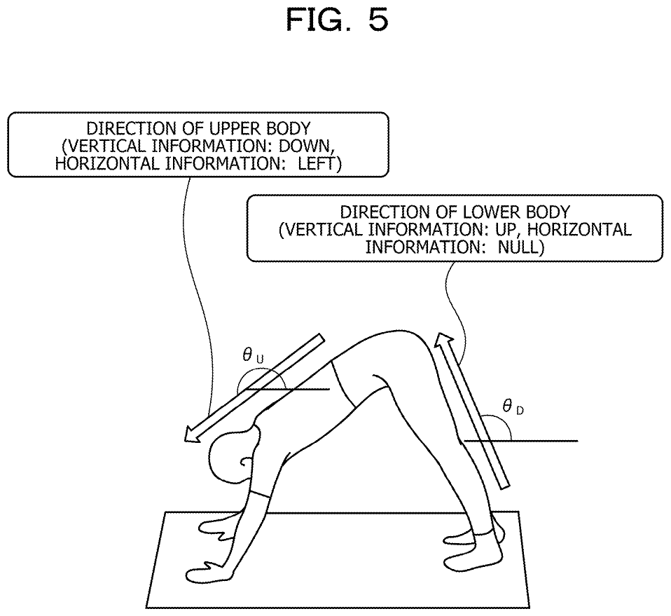

FIG. 5 is a diagram for explaining a process of the information processing apparatus. An example of the vertical information and the horizontal information to be given to the direction of the upper body and the direction of the lower body by the information processing apparatus 100 will be described with reference to FIG. 5. In the image frame of FIG. 5, the angle of the upper body is denoted by θ_{U}, and the angle of the lower body is denoted by θ_{D}.

For example, the information processing apparatus 100 sets the vertical information “down” and the horizontal information “left” as the direction of the upper body when the angle θ_{U} of the upper body is included in “180 degree+X degree” to “0 degree−X degree” and is included in “90 degree+Y degree” to “270 degree−Y degree”.

The information processing apparatus 100 sets the vertical information “up” and the horizontal information “NULL” as the direction of the lower body when the angle θ_{D} of the lower body is included in “0 degree+X degree” to “180 degree−X degree” and is included in “90 degree−Y degree” to “90 degree+Y degree”.

The information processing apparatus 100 specifies the posture of the person 10 based on a combination of the direction of the upper body and the direction of the lower body specified by the above process and the joint angle specified from the skeleton data. In this way, by using the direction of the upper body and the direction of the lower body, it is possible to narrow down to a realistic posture and to uniquely specify the posture.

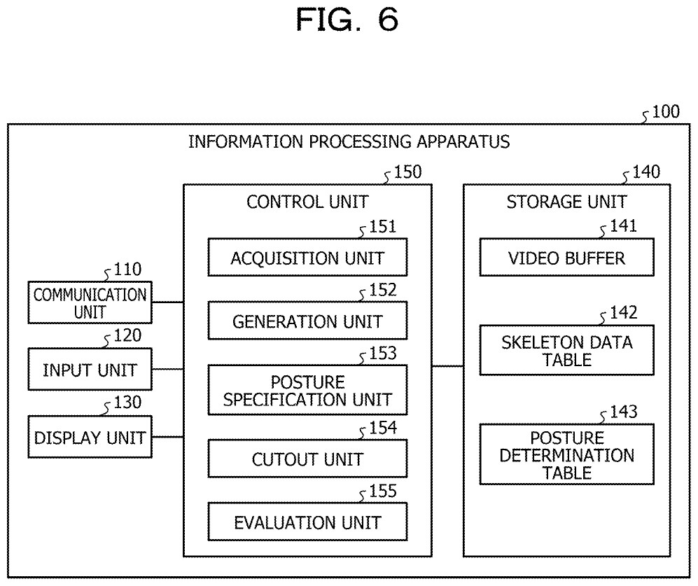

Next, an example of a configuration of the information processing apparatus 100 illustrated in FIG. 2 will be described. FIG. 6 is a functional block diagram illustrating the configuration of the information processing apparatus according to the present embodiment. As illustrated in FIG. 6, the information processing apparatus 100 includes a communication unit 110, an input unit 120, a display unit 130, a storage unit 140, and a control unit 150.

The communication unit 110 is coupled to the camera 20 and receives video data. For example, the communication unit 110 is realized by a network interface card (NIC) or the like. The communication unit 110 may be coupled to another external device or the like via a network 30.

The input unit 120 is an input device that inputs various kinds of information to the information processing apparatus 100. The input unit 120 corresponds to a keyboard, a mouse, a touch panel, or the like.

The display unit 130 is a display device that displays information output from the control unit 150. The display unit 130 corresponds to a liquid crystal display, an organic electro luminescence (EL) display, a touch panel, or the like.

The storage unit 140 includes a video buffer 141, a skeleton data table 142, and a posture determination table 143. The storage unit 140 is implemented by, for example, a semiconductor memory element such as a random access memory (RAM) or a flash memory, or a storage device such as a hard disk or an optical disk.

The video buffer 141 is a buffer for storing video data transmitted from the camera 20. The video data includes a plurality of time-series image frames. It is assumed that each of the image frames is assigned the frame number in ascending order of time series.

The skeletal data table 142 is a table for holding the skeletal data generated from each image frame. The skeleton data is generated by the generation unit 152 described later. Each skeleton data is assigned with the frame number of a corresponding image frame.

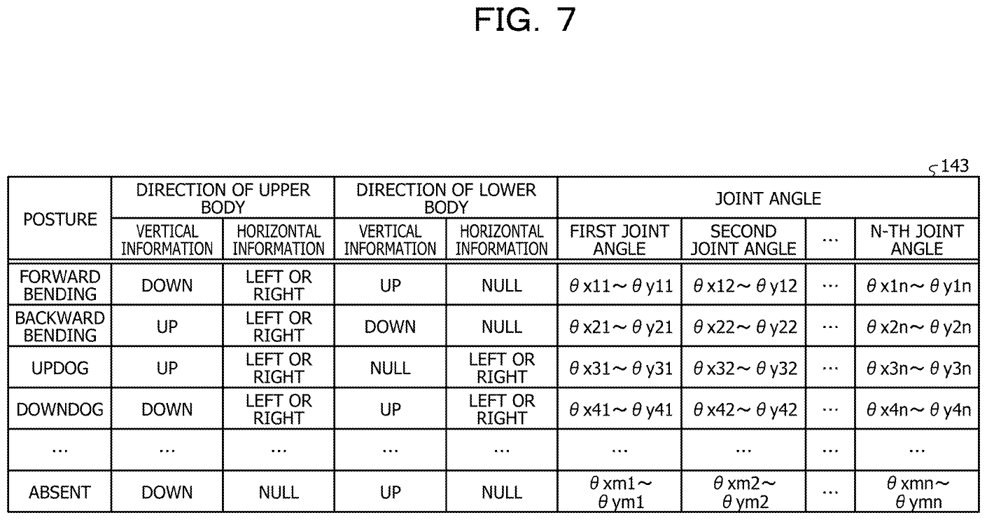

The posture determination table 143 holds information for identifying a posture. FIG. 7 is a diagram illustrating an example of a data structure of the posture determination table. As illustrated in FIG. 7, the posture determination table 143 associates the posture, the direction of the upper body, the direction of the lower body, and the joint angle with one another.

The posture indicates a type of posture, and corresponds to a forward bending, a backward bending, an up dock, a down dock, and the like. The direction of the upper body includes the vertical information and the horizontal information. The direction of the lower body includes the vertical information and the horizontal information. The joint angle includes a first joint angle, a second joint angle, and an n-th joint angle. Each joint angle corresponds to a knee joint, an elbow joint, a shoulder joint, a body trunk (forward bending and backward bending), and the like.

For example, when the conditions of the direction of the upper body (vertical information: down, horizontal information: left or right), the direction of the lower body (vertical information: up, horizontal information: NULL), the first joint angle (θx11 to θy11), the second joint angle (θx12 to θy12), and the n-th joint angle (θx1n to θy1n) are satisfied, it is indicated that the posture of the person is “forward bending”.

Each joint angle is an angle formed by a line segment passing through a predetermined joint. For example, the angle of the knee joints is specified by the angle formed by the line segment passing through the joint A14 (A10) and the joint A15 (A11) and the line segment passing through the joint A15 (A11) and the joint A16 (A12) illustrated in FIG. 3. Other joints are defined in the same manner.

Note that in the posture determination table 143, a posture “absent” which does not correspond to any posture is defined. It is assumed that the posture becomes “absent” while the person 10 changes the posture from a current posture to another posture.

The description returns to FIG. 6. The control unit 150 includes an acquisition unit 151, a generation unit 152, a posture specification unit 153, a cutout unit 154, and an evaluation unit 155. The control unit 150 is realized by, for example, a central processing unit (CPU) or a micro processing unit (MPU). Further, the control unit 150 may be implemented, for example, by an integrated circuit such as an application specific integrated circuit (ASIC) or a field programmable gate array (FPGA).

The acquisition unit 151 acquires video data from the camera 20 via the communication unit 110. The acquisition unit 151 registers the acquired video data in the video buffer 141.

The generation unit 152 acquires image frames in time series from the video buffer 141 and generates skeleton data of a person included in the image frames. For example, the generation unit 152 generates the skeleton data by inputting the image frame to a skeleton estimation model (not illustrated). The generation unit 152 assigns the frame number of the image frame to the skeleton data and registers the skeleton data in the skeleton data table 142.

The skeleton estimation model is a machine learning model that outputs the skeleton data when a region of the person in the image frame (a whole body image) is input. The skeleton estimation model may be implemented by a machine learning model such as OpenPose. The skeleton data includes “two dimensional coordinates” of each joint. The joints included in the skeleton data correspond to the joints A0 to A24 illustrated in FIG. 3.

The generation unit 152 acquires the image frames in time series from the video buffer 141 and repeatedly executes the above process.

The posture specification unit 153 acquires the skeleton data from the skeleton data table 142 and specifies each joint angle and the direction of the part of the person. The posture specification unit 153 specifies a posture corresponding to the skeleton data based on a specified combination of each joint angle and the directions of the parts of the person and the posture determination table 143.

A process of specifying each joint angle by the posture specification unit 153 will be described. The posture specification unit 153 specifies, as the joint angle, an angle formed by line segments passing through predetermined joints set in advance for each type of the joint angle. For example, when the posture specification unit 153 specifies the angle of the knee joint, the posture specification unit 153 specifies, as the angle of the knee joint, the angle formed by a line segment passing through the joint A14 (A10) and the joint A15 (A11) which are included in the skeleton data and a line segment passing through the joint A15 (A11) and the joint A16 (A12) which are included in the skeleton data. The posture specification unit 153 specifies the joint angle in the same manner for the other joint angles.

A process in which the posture specification unit 153 specifies the direction of the part of the person will be described. The posture specification unit 153 specifies the angle of the upper body and the angle of the lower body. For example, the posture specification unit 153 specifies an angle determined based on a line segment from the joint A0 to the joint A2 in the skeleton data and the horizontal direction as the angle of the upper body. The posture specification unit 153 specifies an angle determined based on a line segment from the joint A14 to the joint A15 (from the joint A10 to the joint A11) and the horizontal direction as the angle of the lower body.

The posture specification unit 153 specifies the vertical information and the horizontal information to be set as the direction of the upper body based on the angle of the upper body and the setting policy of the vertical information and the horizontal information described in FIG. 4. For example, when the angle θ_{U} of the upper body is included in from “180 degree+X degree” to “0 degree−X degree” and is included in from “90 degree+Y degree” to “270 degree−Y degree”, the posture specification unit 153 sets the vertical information “down” and the horizontal information “left” as the direction of the upper body.

The posture specification unit 153 specifies the vertical information and the horizontal information to be set as the direction of the lower body based on the angle of the lower body and the setting policy of the vertical information and the horizontal information described in FIG. 4. For example, when the angle θ_{D} of the lower body is included in “0 degree+X degree” to “180 degree−X degree” and is included in “90 degree−Y degree” to “90 degree+Y degree”, the posture specification unit 153 sets the vertical information “up” and the horizontal information “NULL” as the direction of the lower body.

The posture specification unit 153 executes the above process, and thereby, the direction of the upper body (the vertical information, the horizontal information), the direction of the lower body (the vertical information, the horizontal information), and each joint angle are specified from the skeleton data.

The posture specification unit 153 compares the combination of the direction of the upper body (the vertical information, the horizontal information), the direction of the lower body (the vertical information, the horizontal information), and each joint angle with the posture determination table 143 to specify the posture. For example, the direction of the upper body (the vertical information: down, the horizontal information: left) and the direction of the lower body (vertical information: up, horizontal information: NULL) are set. Further, it is assumed that the respective joint angles are included in the first joint angle (θx11 to θy11), the second joint angle (θx12 to θy12), and the n-th joint angle (θx1n to θy1n). In this case, since the posture corresponds to the posture “forward bending” illustrated in FIG. 7, the posture specification unit 153 specifies that the posture is the forward bending.

The posture specification unit 153 outputs a posture specification result to the cutout unit 154. The posture specification result includes the specified posture and the frame number of the skeleton data (image frame). The posture specification unit 153 reads out the skeleton data registered in the skeleton data table 142 and repeatedly executes the above process.

The cutout unit 154 sequentially acquires the posture specification result from the posture specification unit 153 and cuts out the posture. The cutout unit 154 outputs the cutout result to the evaluation unit 155. For example, the cutout unit 154 executes any one of a first cutout process, a second cutout process, and a third cutout process.

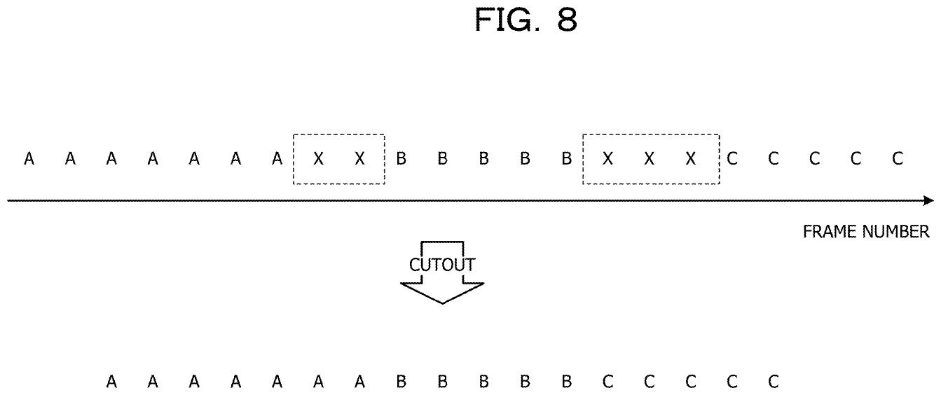

An example of the first cutout process executed by the cutout unit 154 will be described. FIG. 8 is a diagram for explaining the example of the first cutout process. In the first cutout process, the cutout unit 154 acquires the posture specification result in the order of the frame number, and performs cutout in accordance with a number of consecutive identical postures. The cutout unit 154 removes the postures in which the number of consecutive postures is equal to or less than 3 as noise.

In FIG. 8, A, B, C, and X indicate certain postures. A number of consecutive postures “A” is “6”. A number of consecutive postures “B” is “5”. A number of consecutive postures “C” is “5”. A number of consecutive postures “X” in first halves is “2”. A number of consecutive postures “X” in second halves is “3”. When a threshold value of the number of consecutive postures is “3”, the cutout unit 154 cutouts the postures “A”, “B”, and “C” by removing the postures “X” as noise.

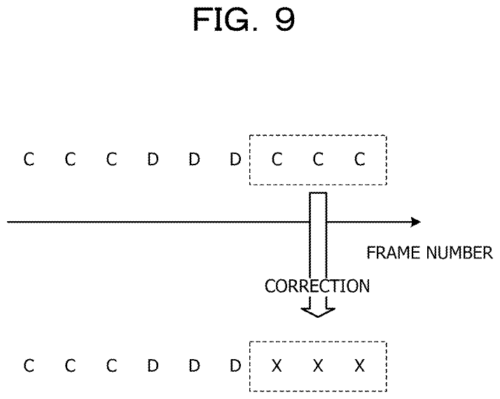

An example of the second cutout process executed by the cutout unit 154 will be described. FIG. 9 is a diagram for explaining the example of the second cutout process. In the second cutout process, the cutout unit 154 acquires the posture specification result in the order of the frame number, and collects the identical postures having consecutive frame numbers. In the example illustrated in FIG. 9, the cutout unit 154 collects the postures into “CCC”, “DDD”, and “CCC”. When the identical posture appears a plurality of times, the cutout unit 154 corrects the posture of the second time and thereafter to a predetermined posture.

In FIG. 9, the cutout unit 154 corrects “CCC” appearing for the second time to “XXX”.

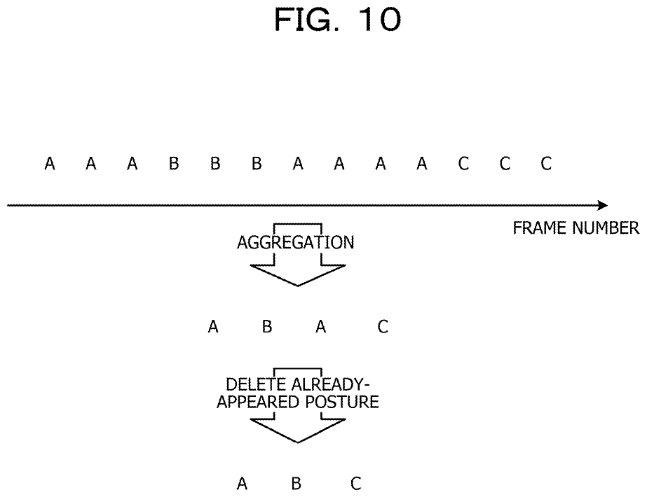

An example of the third cutout process executed by the cutout unit 154 will be described. FIG. 10 is a diagram for explaining the example of the third cutout process. In the third cutout process, the cutout unit 154 acquires the posture specification result in the order of the frame number, and aggregates a plurality of postures having consecutive frame numbers into one posture. When the posture that has already appeared appears again, the cutout unit 154 deletes the posture of the second time and thereafter.

In FIG. 10, the cutout unit 154 aggregates “AAA” into “A”, aggregates “BBB” into “B”, aggregates “AAAA” into “A”, and aggregates “CCC” into “C”. Further, the cutout unit 154 cutouts “A, B, C” by deleting “A” that appears for the second time. The third cutout process may allow unique aggregation of the postures while maintaining an order of the postures that appear.

The description returns to FIG. 6. The evaluation unit 155 is a processing unit that evaluates each posture cut out by the cutout unit 154. The evaluation unit 155 acquires the skeleton data of the person 10 corresponding to the posture from the skeleton data based on the frame number corresponding to the posture, and specifies the joint angle. The process of specifying the joint angle by the evaluation unit 155 is the same as that of the posture specification unit 153. The evaluation unit 155 evaluates the posture based on a degree of deviation between a reference joint angle regarding the posture and the joint angle obtained from the skeleton data, and calculates an evaluation value.

When calculating the evaluation value of the posture, the evaluation unit 155 increases the evaluation value as the joint angle is closer to the reference joint angle. It is assumed that the evaluation unit 155 holds information on the reference joint angle regarding the posture. The evaluation unit 155 calculates a total value by summing the evaluation values of the respective postures.

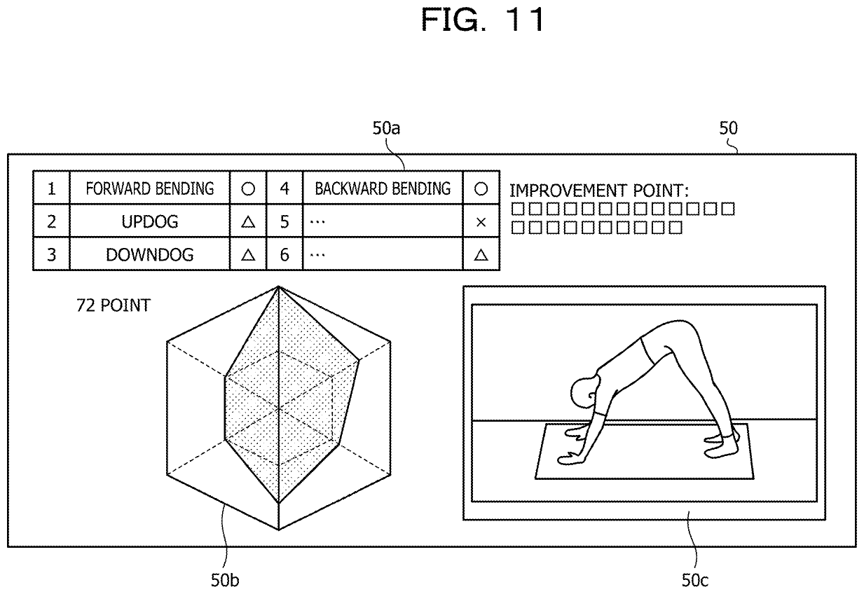

The evaluation unit 155 generates information of an evaluation screen based on a evaluation result. FIG. 11 is a diagram illustrating an example of an evaluation screen. As illustrated in FIG. 11, the evaluation screen 50 includes a region 50a, a region 50b, and a region 50c. In the area 50a, a relationship between the posture and the evaluation value of the posture is displayed. In the area 50b, a graph corresponding to the evaluation value of each posture, the total value of the evaluation values, and the like are displayed. The area 50c displays the video data registered in the video buffer 141.

The evaluation unit 155 outputs the generated information of the evaluation screen to the display unit 130 and causes the display unit to display the information.

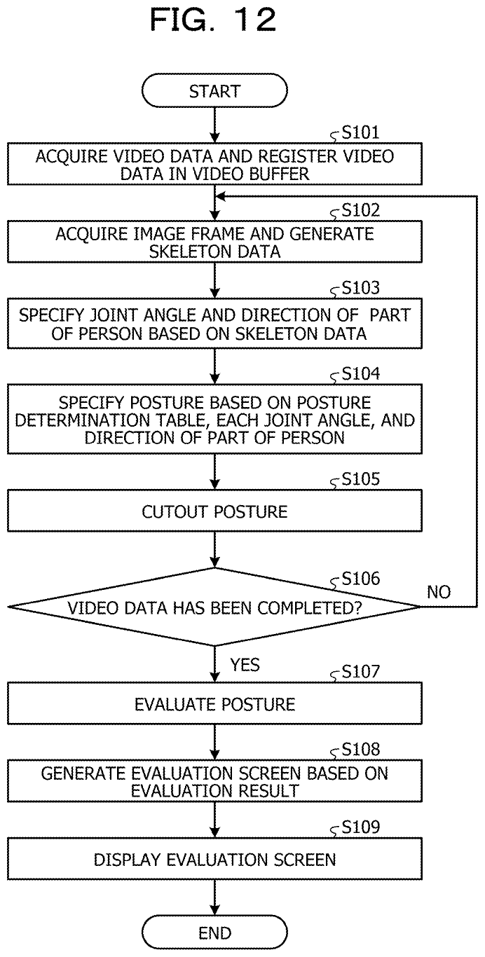

Next, an example of a process procedure of the information processing apparatus 100 according to the present embodiment will be described. FIG. 12 is a flowchart illustrating the process procedure of the information processing apparatus according to the present embodiment. As illustrated in FIG. 12, the acquisition unit 151 of the information processor 100 acquires the video data from the camera 20 and registers the video data in the video buffer 141 (step S101).

The generation unit 152 of the information processor 100 acquires the image frame from the video buffer 141 and generates the skeleton data (step S102). The posture specification unit 153 of the information processor 100 specifies each joint angle and the direction of the part of the person based on the skeleton data (step S103).

The posture specification unit 153 specifies the posture based on the posture determination table 143, each joint angle, and the direction of the part of the person (step S104). The cutout unit 154 of the information processor 100 cutouts the posture (step S105).

If the video data has not been completed (No at step S106), the information processor 100 proceeds to step S102. On the other hand, when the video data has been completed (Yes at step S106), the information processor 100 proceeds to step S107.

The evaluation unit 155 of the information processor 100 evaluates the posture (step S107). The evaluation unit 155 generates the evaluation screen based on the evaluation result (step S108). The evaluation unit 155 displays the evaluation screen on the display unit 130 (step S109).

Next, the effect of the information processing apparatus 100 according to the present embodiment will be described. The information processing apparatus 100 sets a plurality of joint angles and a direction of a part of a person based on skeleton data, and specifies a posture of the person based on the plurality of joint angles and the direction of the part of the person. The information processing apparatus 100 may uniquely specify the posture by using a combination of the plurality of node angles and the direction of the part of the person.

When the angle of the direction of the part with respect to the horizontal direction serving a reference is equal to or larger than a first angle, the information processing apparatus 100 sets one of an upward direction and a downward direction as the direction of the part. This makes it possible to prevent the vertical information “up” or “down” from being assigned when the direction of the part is likely to change vertically.

When the angle of the direction of the part with respect to the vertical direction serving a reference is equal to or larger than a second angle, the information processing apparatus 100 sets one of a left direction and a right direction as the direction of the part. This may prevent the horizontal information “right” or “left” from being assigned when the direction of the part is likely to change to horizontally.

The information processing apparatus 100 corrects the type of the posture based on a pattern of the consecutive postures. Thus, a posture useful for evaluation may be obtained.

The information processing apparatus 100 calculates each evaluation value based on the skeleton data corresponding to the posture, and calculates a total value obtained by summing the respective evaluation values of each posture. Thus, the evaluation result related to each posture performed by the person may be easily grasped.

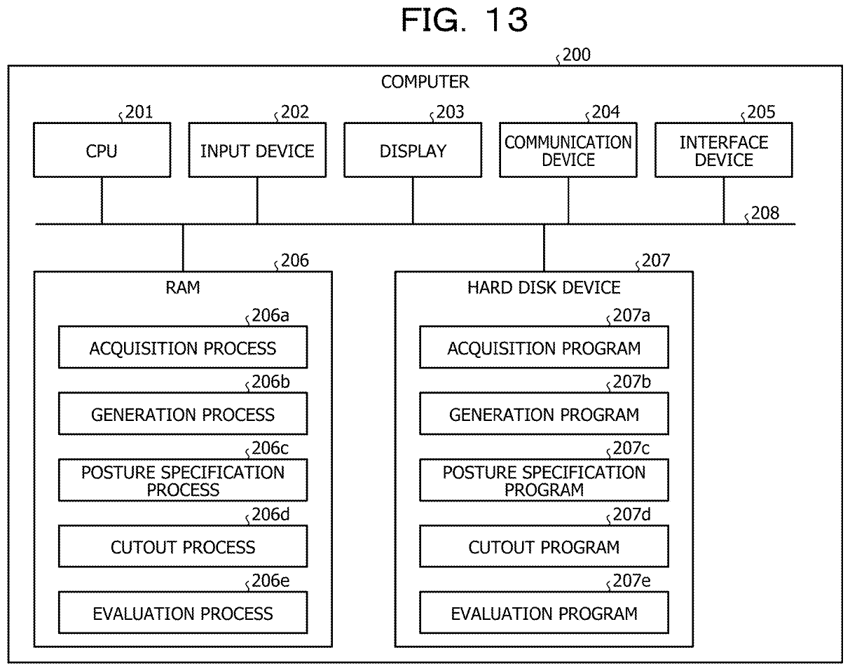

Next, an example of a hardware configuration of a computer that realizes the same function as that of the information processing apparatus 100 described in the above embodiment will be described. FIG. 13 is a diagram illustrating an example of the hardware configuration of the computer that realizes the same function as that of the information processing apparatus according to the embodiment.

As illustrated in FIG. 13, a computer 200 includes a CPU 201 that executes various arithmetic processes, an input device 202 that receives data from a user, and a display 203. Further, the computer 200 further includes a communication device 204 that transmits and receives data to and from the camera 20, an external device, and the like via a wired or wireless network, and an interface device 205. Further, the computer 200 also includes a RAM 206 that temporarily stores various kinds of information and a hard disk device 207. Further, the devices 201 to 207 are coupled to a bus 208.

The hard disk device 207 includes an acquisition program 207a, a generation program 207b, a posture specification program 207c, a cutout program 207d, and an evaluation program 207e. In addition, the CPU 201 reads each of the programs 207a to 207e and develops the programs in the RAM 206.

The acquisition program 207a functions as an acquisition process 206a. The generation program 207b functions as a generation process 206b. The posture specification program 207c functions as a posture specification process 206c. The cutout program 207d functions as a cutout process 206d. The evaluation program 207e functions as an evaluation process 206e.

A process of the acquisition process 206a corresponds to a process of the acquisition unit 151. A process of the generation process 206b corresponds to A process of the generation unit 152. A process of the posture specification process 206c corresponds to a process of the posture specification unit 153. A processing of the cutout process 206d corresponds to A process of the cutout unit 154. The process of the evaluation process 206e corresponds to the process of the evaluation unit 155.

Note that the programs 207a to 207e may not necessarily be stored in the hard disk device 207 from the beginning. For example, each program is stored in a “portable physical medium” such as a flexible disk (FD), a CD-ROM, a DVD, a magneto-optical disk, or an IC card which is inserted into the computer 200. Then, the computer 200 may read and execute the programs 207a to 207e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a posture specification program causing a computer to execute:
generating skeleton information indicating two dimensional coordinates of a plurality of joints of a person based on visual information which is obtained by capturing the person;
setting angles of the plurality of joints and a direction of a part of the person based on the skeleton information; and
specifying a posture of the person based on the angles of the plurality of joints and the direction of the part of the person.

2. The non-transitory computer-readable recording medium according to claim 1, wherein
the setting of the direction of the part includes setting, as the direction of the part, one of an upward direction and a downward direction based on the direction of the part when an angle of the direction of the part with respect to a horizontal direction is equal to or larger than a first angle.

3. The non-transitory computer-readable recording medium according to claim 1, wherein
the setting of the direction of the part includes setting, as the direction of the part, one of a left direction and a right direction based on the direction of the part when an angle of the direction of the part with respect to a vertical direction is equal to or larger than a second angle.

4. The non-transitory computer-readable recording medium according to claim 1, wherein
the specifying the posture includes:
repeatedly executing the specifying the posture every time the angles of the plurality of joints and the direction of the part of the person are set; and
correcting a type of the posture based on a pattern of consecutive postures specified by the specifying the posture.

5. The non-transitory computer-readable recording medium according to claim 1, further comprising:
specifying an angle of a joint based on the skeletal information corresponding to the posture specified by the specifying the posture.

6. The non-transitory computer-readable recording medium according to claim 5, further comprising:
calculating a score for each of postures based on the angle of the joint of the respective postures and a reference angle of the joint of the respective postures; and
calculating a total score of the postures.

7. A posture specification method comprising:
generating skeleton information indicating two dimensional coordinates of a plurality of joints of a person based on visual information which is obtained by capturing the person;
setting angles of the plurality of joints and a direction of a part of the person based on the skeleton information; and
specifying a posture of the person based on the angles of the plurality of joints and the direction of the part of the person.

8. The posture specification method according to claim 7, wherein
the setting of the direction of the part includes setting, as the direction of the part, one of an upward direction and a downward direction based on the direction of the part when an angle of the direction of the part with respect to a horizontal direction is equal to or larger than a first angle.

9. The posture specification method according to claim 7, wherein
the setting of the direction of the part includes setting, as the direction of the part, one of a left direction and a right direction based on the direction of the part when an angle of the direction of the part with respect to a vertical direction is equal to or larger than a second angle.

10. The posture specification method according to claim 7, wherein
the specifying the posture includes:
repeatedly executing the specifying the posture every time the angles of the plurality of joints and the direction of the part of the person are set; and
correcting a type of the posture based on a pattern of consecutive postures specified by the specifying the posture.

11. The posture specification method according to claim 7, further comprising:
specifying an angle of a joint based on the skeletal information corresponding to the posture specified by the specifying the posture.

12. The posture specification method according to claim 11, further comprising:
calculating a score for each of postures based on the angle of the joint of the respective postures and a reference angle of the joint of the respective postures; and
calculating a total score of the postures.

13. An information processing apparatus comprising:
a memory; and
a processor coupled to the memory and configured to perform a process of:
generating skeleton information indicating two dimensional coordinates of a plurality of joints of a person based on visual information which is obtained by capturing the person;
setting angles of the plurality of joints and a direction of a part of the person based on the skeleton information; and
specifying a posture of the person based on the angles of the plurality of joints and the direction of the part of the person.

14. The information processing apparatus according to claim 13, wherein
the setting of the direction of the part includes setting, as the direction of the part, one of an upward direction and a downward direction based on the direction of the part when an angle of the direction of the part with respect to a horizontal direction is equal to or larger than a first angle.

15. The information processing apparatus according to claim 13, wherein
the setting of the direction of the part includes setting, as the direction of the part, one of a left direction and a right direction based on the direction of the part when an angle of the direction of the part with respect to a vertical direction is equal to or larger than a second angle.

16. The information processing apparatus according to claim 13, wherein
the specifying the posture includes:
repeatedly executing the specifying the posture every time the angles of the plurality of joints and the direction of the part of the person are set; and
correcting a type of the posture based on a pattern of consecutive postures specified by the specifying the posture.

17. The information processing apparatus according to claim 13, wherein the process includes:
specifying an angle of a joint based on the skeletal information corresponding to the posture specified by the specifying the posture.

18. The information processing apparatus according to claim 17, wherein the process includes:
calculating a score for each of postures based on the angle of the joint of the respective postures and a reference angle of the joint of the respective postures; and
calculating a total score of the postures.
